(19) United States
(12) Patent Application Publication
(10) Pub. No.: US 2025/0307884 A1
(43) Pub. Date: Oct. 2, 2025

(54) METHOD AND SYSTEM FOR PROVIDING REVIEW MANAGEMENT SERVICE

(71) Applicant: NAVER CORPORATION, Seongnam-si (KR)

(72) Inventors: Jeong Min LEE, Seongnam-si (KR); Joo Youl LIM, Seongnam-si (KR); Se Lin HA, Seongnam-si (KR); Ye Jin KIM, Seongnam-si (KR); Yon Jai IM, Seongnam-si (KR); Yung Seong LEE, Seongnam-si (KR)

(73) Assignee: NAVER CORPORATION, Seongnam-si (KR)

(21) Appl. No.: 19/090,945

(22) Filed: Mar. 26, 2025

(30) Foreign Application Priority Data
Mar. 26, 2024 (KR) 10-2024-0041414

(51) Int. Cl. G06Q 30/0282

(52) U.S. Cl. CPC G06Q 30/0282

(57) ABSTRACT

The present disclosure relates to a method of providing a review management service and a system for providing a review management service. The method of providing a review management service may include monitoring registration of review content on a review page, analyzing content included in the review content through a pre-trained artificial intelligence model upon a result of the monitoring indicating that the review content has been registered on the review page, classifying the review content into a rating of multiple ratings based on a result of the analyzing, each of the multiple ratings being associated with multiple different review management processes, and performing one of the multiple different review management processes associated with the rating of the review content to handle the review content.

### CROSS REFERENCE TO RELATED APPLICATION

The present application claims priority to Korean Patent Application No. 10-2024-0041414, filed on Mar. 26, 2024, the entire content of which is incorporated herein for all purposes by reference.

### BACKGROUND

### Field

The present disclosure relates to methods and systems for providing a review management service.

### Description of the Related Art

As technology advances, electronic devices (e.g., smartphones, tablet PCs, automation devices, etc.) have become more popular, and accordingly, there is an increasing dependency on the electronic devices for many aspects of daily life.

As such, with the development of various technologies, including the Internet, consumption patterns that were previously highly dependent on offline activities have gradually shifted to online, and currently, the consumption centered around the online world has been experiencing exponential growth.

Meanwhile, unlike offline services, online services do not allow customers (or consumers) to see the products or experience them firsthand, and there is still a need to improve online consumption.

To address these needs, online services are introducing review services. Reviews created by consumers on online services are considered to be highly reliable information and/or have a significant impact on consumer sentiment and/or behavior.

However, reviews are content generated regardless of the will and actions of the business operator operating a business, and while some of these reviews are positive, there are also malicious reviews, reviews that infringe on rights, negative reviews, and others.

Business operators who manages these various types of reviews are experiencing emotional and time-consuming difficulties in the process of managing reviews, which may have a significant impact on the business operators' business operations.

Further, conventional review services provide a consumer environment that may assist in consumer purchasing decisions. However, from the perspective of the business operator who needs to manage reviews, there is a problem in that conventional review services do not offer sufficient assistance related to the management of the consumer reviews.

Therefore, there is still a need for a service that allows business operators to manage consumer reviews without being influenced emotionally or temporally, in order to assist with the management of the consumer reviews.

### SUMMARY

Some example embodiments of the present disclosure provide methods and systems for providing a review management service that is capable of assisting business operators in managing reviews.

Some example embodiments of the present disclosure provide methods and systems for providing a review management service that enables business operators to confidently manage various types of reviews created by customers (or consumers).

Some example embodiments of the present disclosure provide methods and systems for providing a review management service that classifies reviews created by customers in real time into various types of ratings and/or allows for different actions to be taken for each rating.

Some example embodiments of the present disclosure provide methods and system for providing a review management service that is capable of generating an appropriate draft reply tailored to customer information and/or the content of the review created by the customer.

According to an example embodiment of the present disclosure, a method of providing a review management service may include monitoring registration of review content on a review page, analyzing content included in the review content through a pre-trained artificial intelligence model upon a result of the monitoring indicating that the review content has been registered on the review page, classifying the review content into a rating of multiple ratings based on a result of the analyzing, each of the multiple ratings being associated with multiple different review management processes, and performing one of the multiple different review management processes associated with the rating of the review content to handle the review content.

According to an example embodiment of the present disclosure, a method of providing a review management service may include monitoring registration of review content on a review page, extracting specific information included in the review content based on preset conditions, upon a result of the monitoring indicating that the review content has been registered, creating an input prompt for a generative artificial intelligence model using the extracted specific information, obtaining a draft reply for the review content from the generative artificial intelligence model that has received the input prompt as an input, and providing the draft reply to a management page managing the review page.

In an embodiment, in the analyzing, the review content may be classified into one of the ratings based on whether the review content is a positive review or a negative review through an analysis of content included in the review content, and when the review content is classified as a negative review, the review management page may provide guide information indicating that the review content includes negative content along with the review content.

According to an example embodiment of the present disclosure, a review management system may include a memory configured to store computer-readable instructions and at least one processor. The at least one processor is configured to execute the computer-readable instructions such that the processor is configured to cause the review management system to monitor registration of review content on a review page, analyze content included in the review content through a pre-trained artificial intelligence model upon a result of the monitoring indicating that the review content has been registered on the review page, classify the review content into a rating of multiple ratings based on a result of the analyzing, each of the multiple ratings being associated with multiple different review management processes, and perform one of the multiple different review management processes associated with the rating of the review content to handle the review content.

According to an example embodiment of the present disclosure, there is provided a non-transitory computer-readable recording medium storing a program thereon, which when executed by one or more processors in an electronic device, causes the electronic device to implement a method of providing a review management service, wherein the method includes monitoring registration of review content on a review page, analyzing content included in the review content through a pre-trained artificial intelligence model upon a result of the monitoring indicating that the review content has been registered on the review page, classifying the review content into a rating of multiple ratings based on a result of the analyzing, each of the multiple ratings being associated with multiple different review management processes, and performing one of the multiple different review management processes associated with the rating of the review content to handle the review content.

As described above, the method and system for providing a review management service according to some example embodiments of the present disclosure can monitor the registration of review content on a review page, and analyze the content included in the review content using a pre-trained artificial intelligence model when the monitoring results indicate that the review content has been registered on the review page. Therefore, some example embodiments of the present disclosure enable relatively quick analysis of review content and/or provides relatively immediate feedback to the business operator.

Further, the method and system for providing a review management service according to some example embodiments of the present disclosure can classify the review content into one of the multiple ratings based on the above analysis, and perform one of the multiple different review management processes that handle the review content based on which rating of the multiple ratings the review content is classified into. Therefore, some example embodiments of the present disclosure enable appropriate responses based on each rating, protecting the business operator from malicious reviews. The business operator can reduce the emotional and/or time costs of creating direct replies to review content, provide appropriate replies based on the content of the reviews registered by the customer, and/or improve customer engagement and services, allowing for more efficient business operation.

### BRIEF DESCRIPTION OF THE DRAWINGS

FIG. 1 is a conceptual view for describing a system for providing a review management service according to an example embodiment of the present disclosure.

FIG. 2 and FIG. 3 are flowcharts for describing a review management method according to an example embodiment of the present disclosure.

FIG. 4, FIG. 5, FIG. 6, FIG. 7A, FIG. 7B, and FIG. 7C are conceptual views for describing a review management process by rating of review content according to an example embodiment of the present disclosure.

FIG. 8 is a flowchart for describing a method of providing a draft reply service based on a generative artificial intelligence model in an example embodiment of the present disclosure.

FIG. 9, FIG. 10A, FIG. 10B, FIG. 11, and FIG. 12 are conceptual views for describing an Artificial Intelligence (AI) draft reply service according to an example embodiment of the present disclosure.

### DETAILED DESCRIPTION

Hereinafter, some example embodiments of the present disclosure will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the example embodiment disclosed in the present disclosure, the specific descriptions of publicly known in the related technologies will be omitted when it is determined that the specific descriptions may obscure the subject matter of the example embodiments disclosed in the present disclosure. In addition, it should be interpreted that the accompanying drawings are provided only to allow those skilled in the art to easily understand the disclosed example embodiments disclosed in the present disclosure, and the technical spirit disclosed in the present disclosure is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

As used herein, expressions such as “one of,” “one or more of,” “any one of,” and “at least one of,” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

Some example embodiments of the present disclosure provide method and systems for providing a review management service that allows business operators to confidently manage various types of reviews created by customers (or consumers). In particular, some example embodiments of the present disclosure classify reviews created in real-time by customers into various types of ratings, allowing different actions to be taken for each rating, and/or may generate an appropriate draft reply tailored to customer information and the content of the review created by the customer.

A system for providing a review management service according to some example embodiments of the present disclosure may also be referred to as a “review content management service providing system,” “review management system,” or “review content management system.” This system for providing a review management service may provide a user environment that allows a business operator operating a specific business to manage customer reviews without being influenced in terms of emotion or time.

In some example embodiments of the present disclosure, a business operator may provide services to consumers in order to produce tangible goods. Here, “service” refers to the labor provided by the business operator to the customer, and various types of services may exist depending on the business operated by the business operator. For example, when the business operator operates a “restaurant,” the types of services may relate to “food provision.” As another example, when the business operator operates a “hair salon,” the types of services may include hair care-related services such as cuts, perms, and so on. In example embodiments of the present disclosure, types of services provided by the business operator are not limited to any specific one.

Accordingly, for the convenience of description in this specification, a party receiving the service (customer, consumer, or user) will be referred to as “customer,” and a party providing the service will be referred to as “business operator.”

The customer and business operator mentioned above may hold accounts that are pre-registered in the system for providing a review management service according to some example embodiments of the present disclosure. For example, the customer may create review content about a service provided by a specific business operator through the account the customer holds, and the business operator may manage the review content created by the customer through the account the business operator holds.

A system for providing a review management service according to some example embodiments of the present disclosure may allow the customer and business operator to use the system for providing a review management service through a page accessible via the Internet (e.g., a web page, the execution screen of an application, or the like).

A page may be a page linked to the system for providing a review management service according to some example embodiments of the present disclosure and may be configured to be controlled by the system for providing a review management service.

Meanwhile, the customer and business operator, based on pre-registered accounts in the system for providing a review management service described above, may perform or receive a series of processes related to creating review content and/or managing review content for the service through the page linked to the system for providing a review management service.

Further, the “account” described above may be generated through the page linked to the system for providing a review management service. In some example embodiments, the “account” may also be generated in at least one other system linked to the system for providing a review management service.

Therefore, in the present disclosure, a system that issues the customer account and business operator account is not separately distinguished, and all accounts that may use the various services provided by the system for providing a review management service according to some example embodiments of the present disclosure are referred to as “pre-registered accounts in the system for providing a review management service.”

Meanwhile, the page linked to the system for providing a review management service, based on the information provided to the system for providing a review management service, may perform a series of processes related to creating review content and managing review content. Such information may be transmitted under the control of the control unit of the system for providing a review management service.

Further, for review content to be created by the customer and managed by the business operator, the transmission and reception of organic information (e.g., data) between the customer, business operator, and system for providing a review management service, is desired.

To this end, the information transmitted from the customer side to the system for providing a review management service, or transmitted from the system for providing a review management service to the customer side, is effectively transmitted from the “electronic device logged in with the customer account” to the system for providing a review management service, or from the system for providing a review management service to the “electronic device logged in with the customer account.” However, for the convenience of description in the present disclosure, without explicitly distinguishing this, when information is transmitted to the “electronic device logged in with the customer account” or received from the “electronic device logged in with the customer account,” it will be described as “information being transmitted to the customer account” or “information being received from the customer account,” with the “customer account” being the subject.

Similarly, the information transmitted from the business operator side to the system for providing a review management service, or transmitted from the system for providing a review management service to the business operator side, is effectively transmitted from the “electronic device logged in with the business operator account” to the system for providing a review management service, or from the system for providing a review management service to the “electronic device logged in with the business operator account.” However, for the convenience of description in this specification, without explicitly distinguishing this, when information is transmitted to the “electronic device logged in with the business operator account” or received from the “electronic device logged in with the business operator account,” it will be described as “information being transmitted to the business operator account” or “information being received from the business operator account,” with the “business operator account” being the subject.

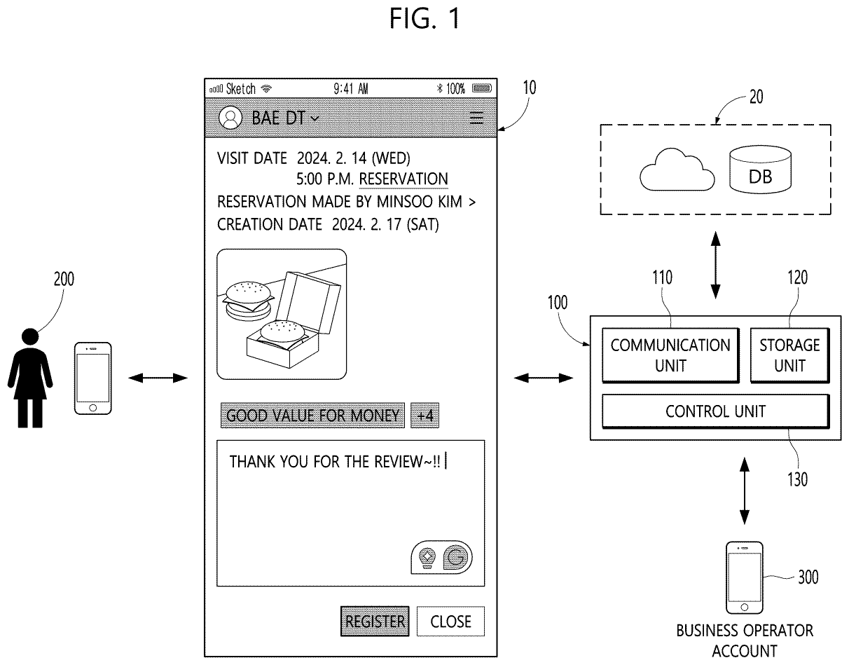

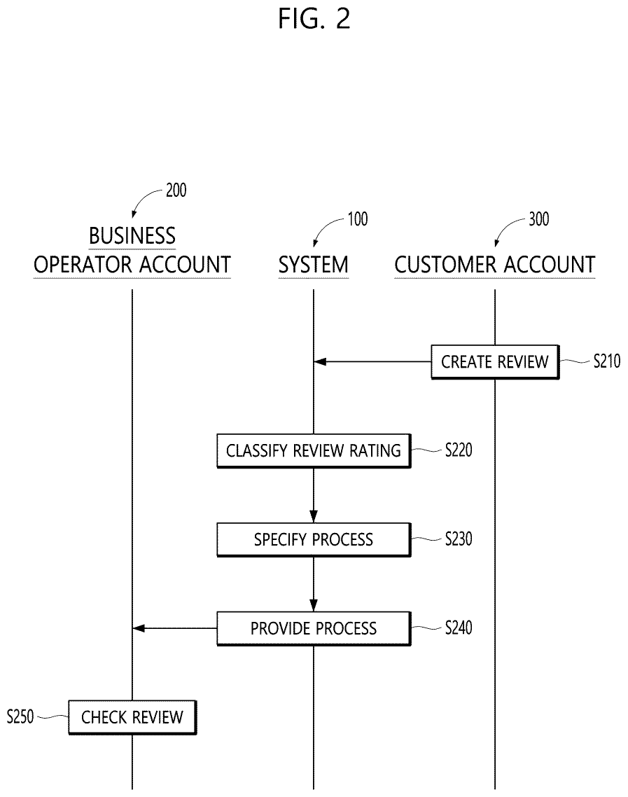

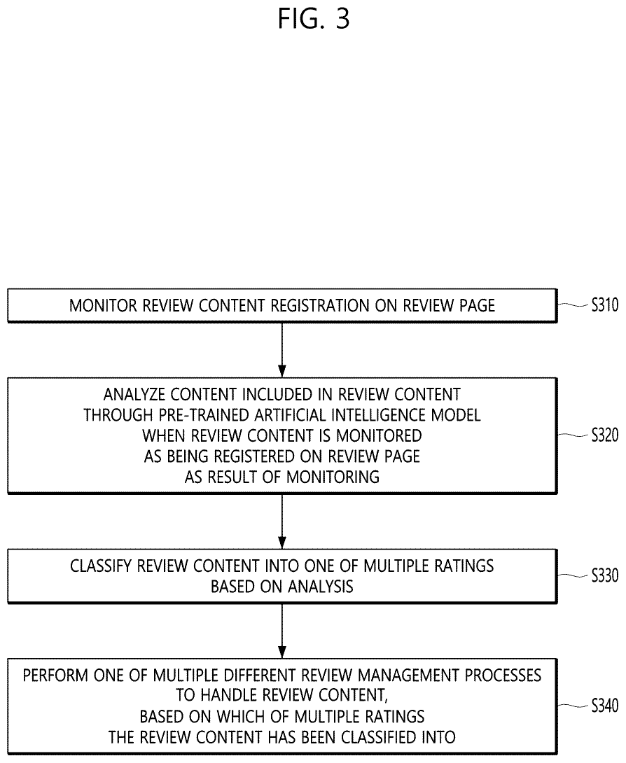

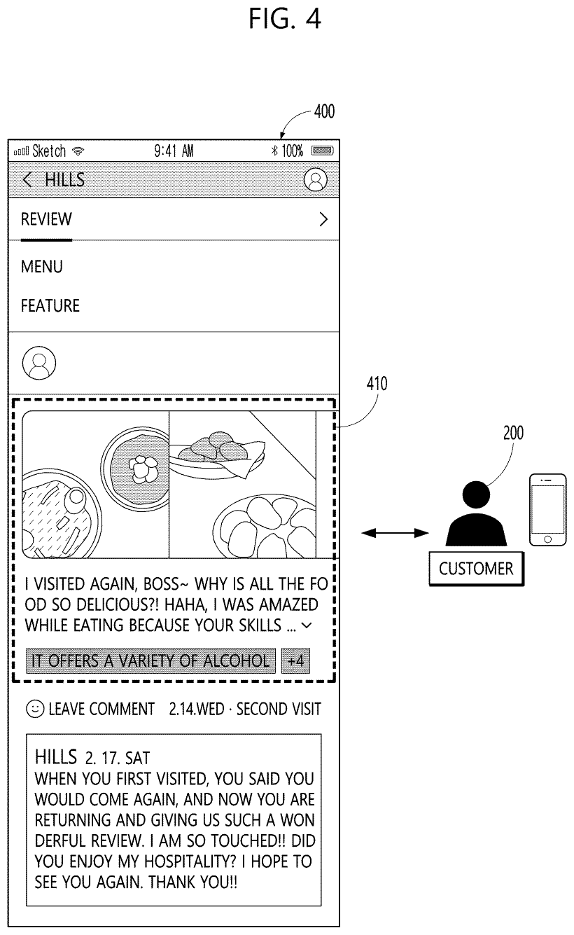

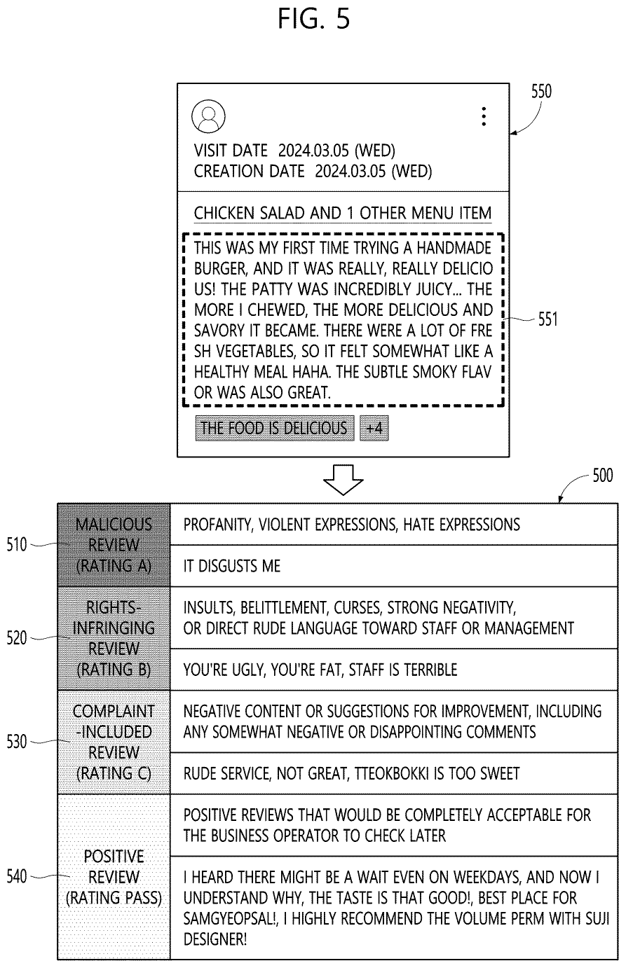

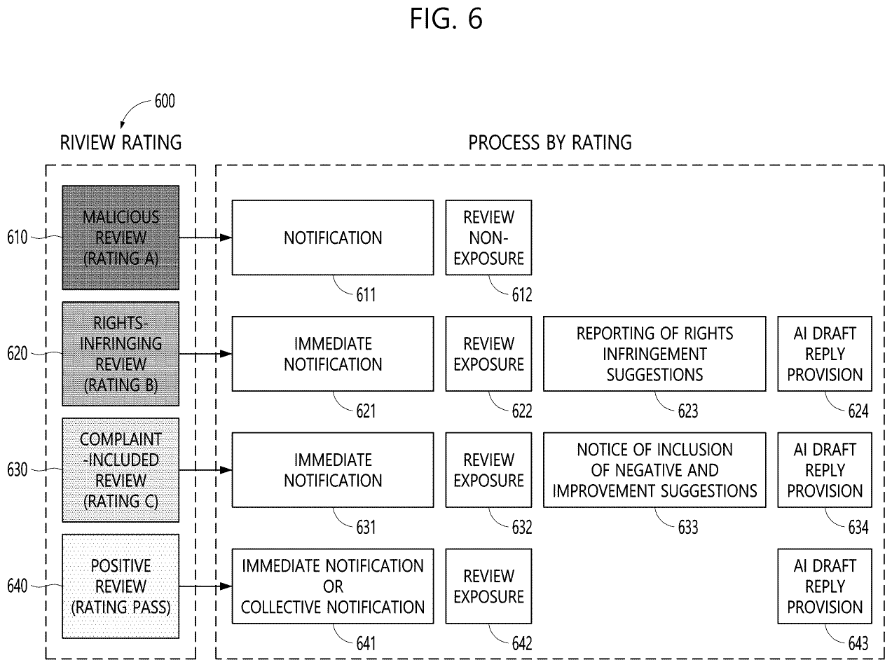

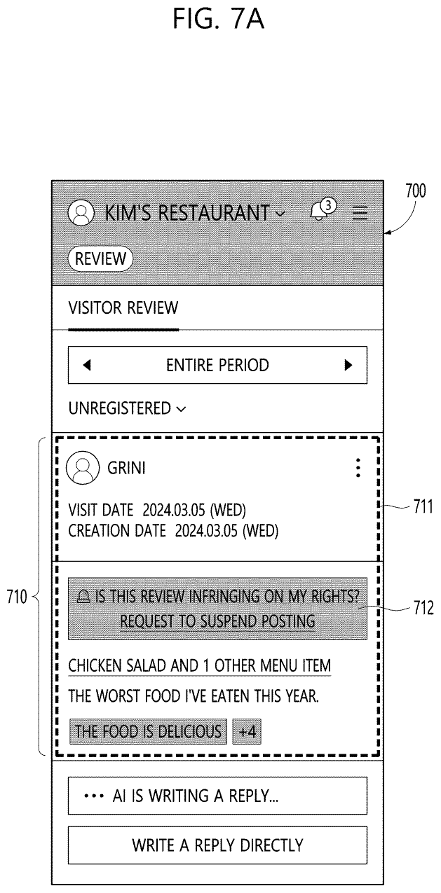

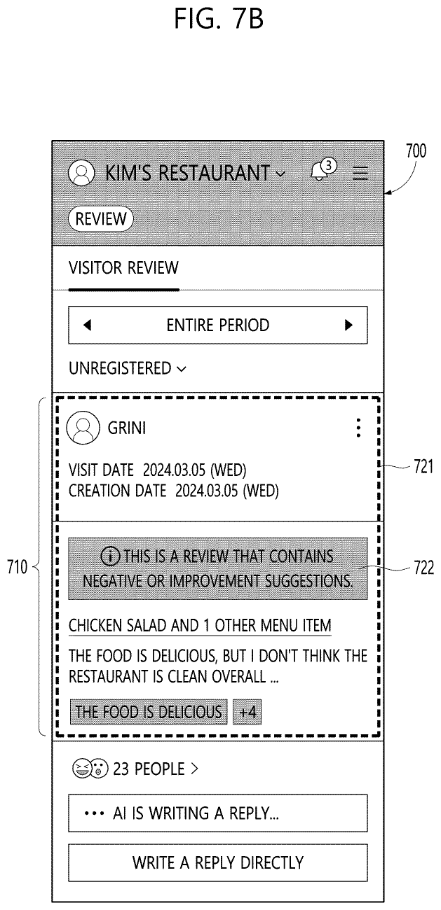

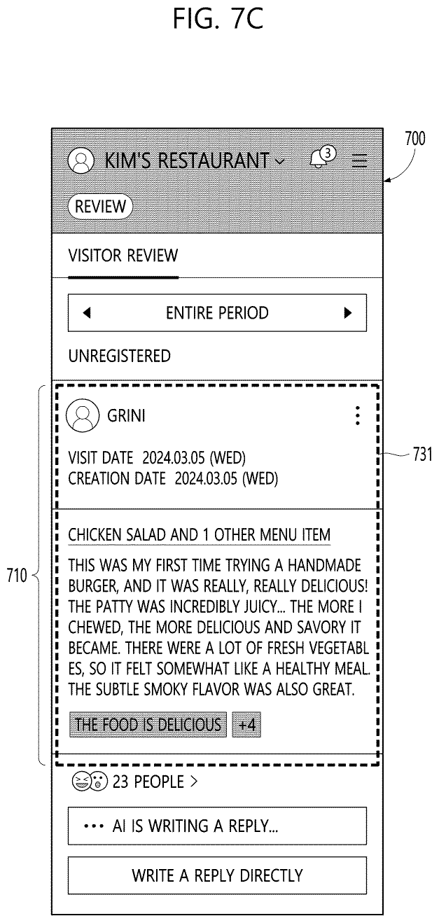

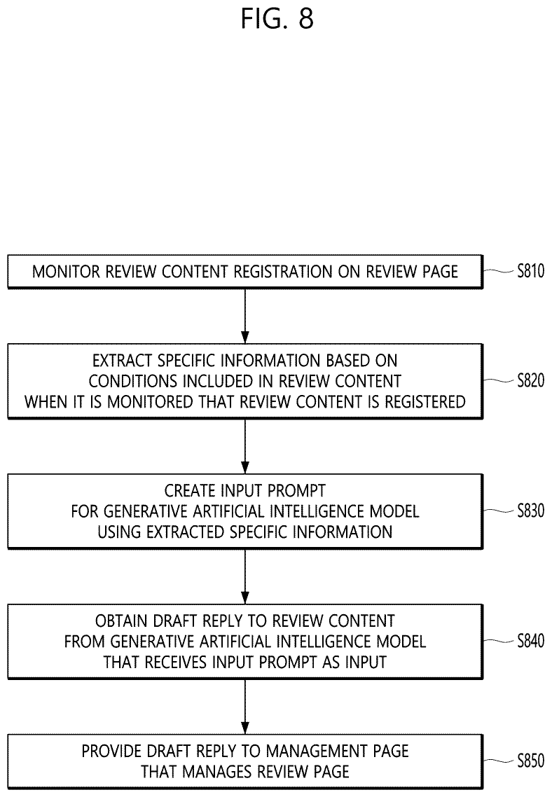

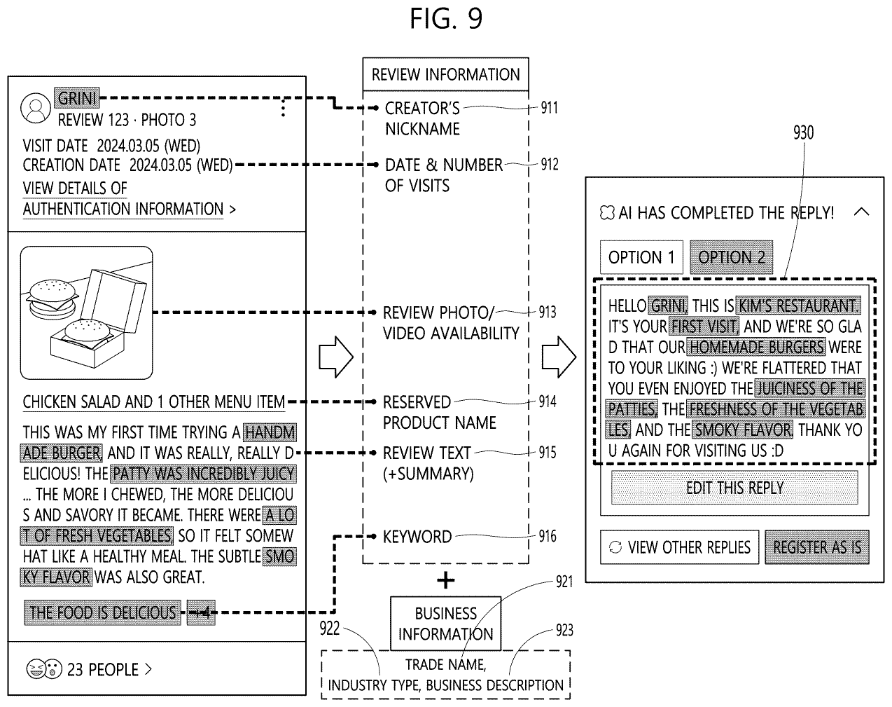

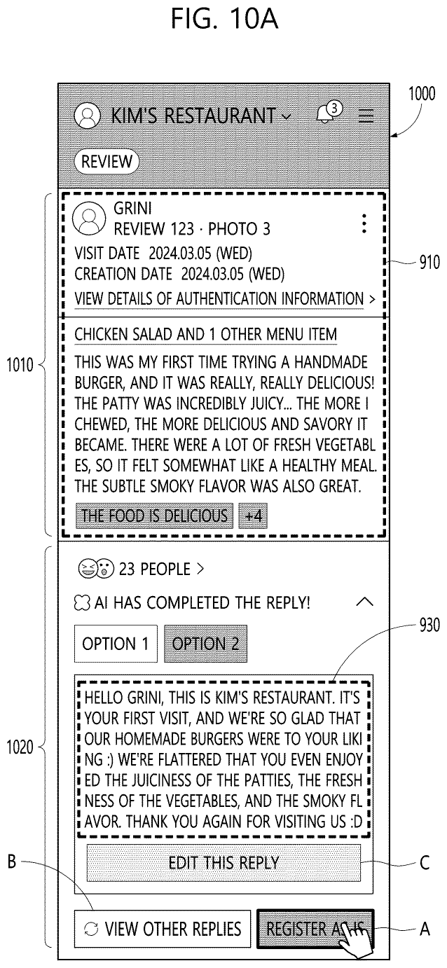

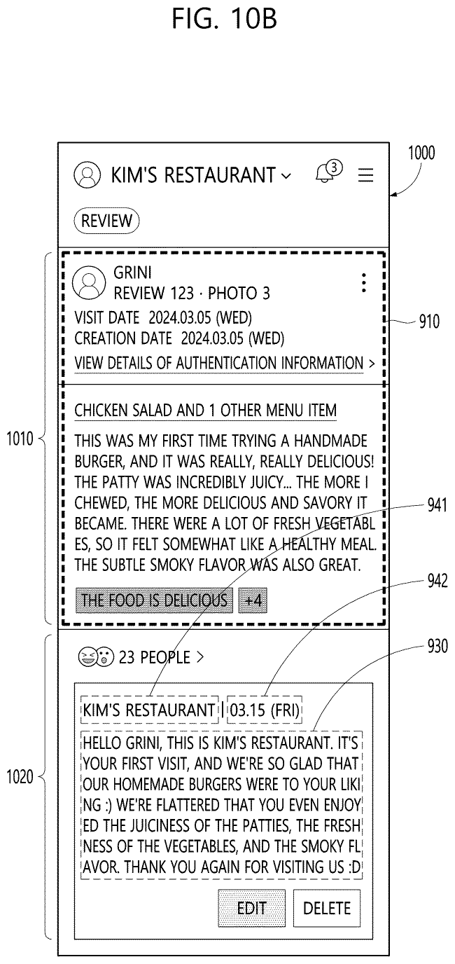

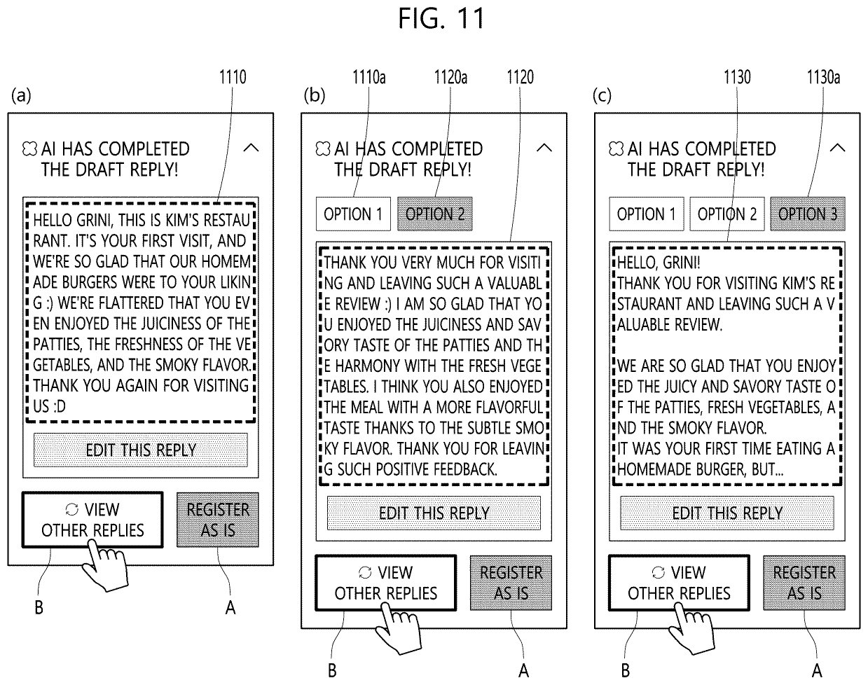

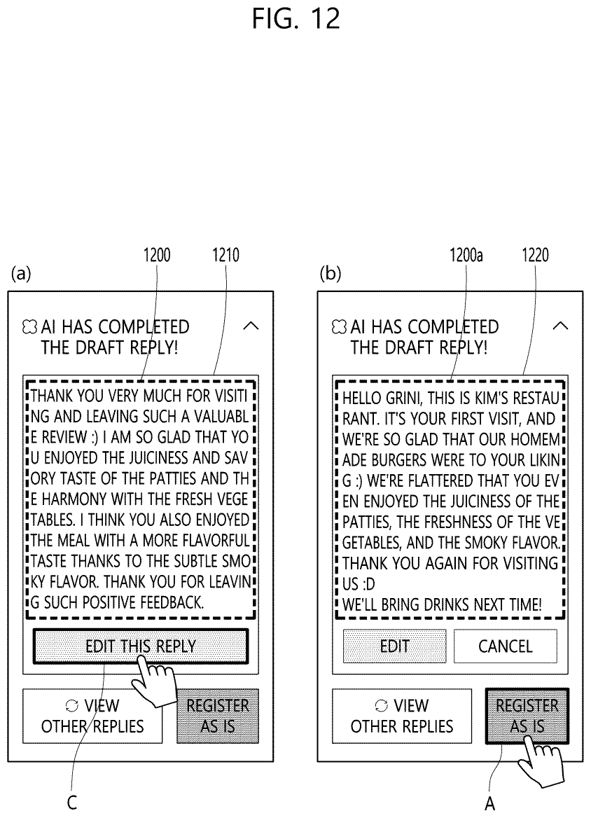

Hereinafter, the configuration of the system for providing a review management service according to some example embodiments of the present disclosure will be described in more detail with reference to the accompanying drawings. FIG. 1 is a conceptual view for describing a system for providing a review management service according to an example embodiment of the present disclosure. FIG. 2 and FIG. 3 are flowcharts for describing a review management method according to an example embodiment of the present disclosure, FIG. 4, FIG. 5, FIG. 6, FIG. 7A, FIG. 7B, and FIG. 7C are conceptual views for describing a review management process by rating of review content according to an example embodiment of the present disclosure, FIG. 8 is a flowchart for describing a method of providing a draft reply service based on a generative artificial intelligence model in an example embodiment of the present disclosure, and FIG. 9, FIG. 10A, FIG. 10B, FIG. 11, and FIG. 12 are conceptual views for describing an Artificial Intelligence (AI) draft reply service according to an example embodiment of the present disclosure.

As illustrated in FIG. 1, a system 100 for providing a review management service according to an example embodiment of the present disclosure may include at least one of a communication unit 110, a storage unit 120, or a control unit 130.

The communication unit 110 may be connected to an artificial intelligence server 20, a cloud server, external servers, devices, etc., through a wireless or wired network, and is configured to receive or transmit the overall data and information for the system 100 to provide a review management service.

Here, the artificial intelligence server 20 may include at least one pre-trained artificial intelligence model. For example, the artificial intelligence server 20 may include an artificial intelligence model trained to perform analysis (or classification) tasks on the content included in the review content. As another example, the artificial intelligence server 20 may include a generative artificial intelligence model trained to generate a draft reply for review content by receiving an input prompt related to the review content as input. However, the processes performed by the artificial intelligence model of the artificial intelligence server 20 may also be carried out independently within the system 100 for providing a review management service.

Meanwhile, in an example embodiment of the present disclosure, the artificial intelligence server 20, cloud server, and external servers may be configured to perform at least a partial role of the control unit 130. That is, data processing or data computation may be performed on the artificial intelligence server 20, cloud server, or external server, but example embodiments of the present disclosure are not limited thereto.

In addition, the communication unit 110 may be configured to communicate with a business operator account 200 and a customer account 300. As described above, in an example embodiment of the present disclosure, the communication with the business operator account 200 and the customer account 300 may be interpreted to refer to communication with the electronic device logged in (or registered) with the customer account and the electronic device logged in (or registered) with the business operator account.

Here, the electronic device may include at least one of a mobile phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), or a head mounted display (HMD)).

Further, the communication unit 110 may support various communication methods depending on the communication standards of devices to be communicated with.

For example, the communication unit 110 may be configured to communicate with a communication target using at least one of wireless LAN (WLAN), wireless-fidelity (Wi-Fi), wireless-fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), fifth generation mobile telecommunication (5G), Bluetooth™ radio frequency identification (RFID), infrared communication (infrared data association (IrDA)), ultra-wideband (UWB), ZigBee, near field communication (NFC), Wi-Fi direct, or wireless universal serial bus (wireless USB) technologies.

Next, the storage unit 120 may also be referred to as a database (DB) or memory and may be configured to store various information. In an example embodiment of the present disclosure, the storage unit 120 may be provided within the system 100 for providing a review management service itself. In some example embodiments, at least a part of the storage unit 120 may be configured as a cloud server (or cloud storage). That is, the storage unit 120 may have a sufficient a space where information desired for the operation of the system 100 to provide a review management service is stored, and there are no constraints on physical space. Hereinafter, the database of the storage unit 120, cloud server (or cloud storage), and artificial intelligence server 20 will not be separately distinguished, and all will be referred to as the storage unit 120.

In the storage unit 120, a pre-registered service in the system 100 for providing a review management service may be stored at the request of the business operator account 200. The pre-registered service in the system 100 for providing a review management service may be of various types depending on the business operated by the business operator. For example, when the business operator operates a “restaurant,” the types of services may relate to “food provision.” As another example, when the business operator operates a “hair salon,” the types of services may include hair care-related services such as cuts, perms, and so on.

That is, the system 100 for providing a review management service may register at least one service item based on the request of the business operator account 200, and this information may be stored in the storage unit 120, and matched with the business operator account 200. In the present disclosure, a detailed description of the process in which service items are registered by the business operator account 200 is omitted, and it will be explained under the assumption that the service items are registered through various methods.

In this regard, the storage unit 120 may store service information according to the services provided by the business operator account 200. For example, the service information may include at least one of service trade name information (e.g., name, title, etc.), service category information (e.g., food industry, beauty industry, etc.), service location information, detailed description information on the service (e.g., business hours, parking, reservations, prices, etc.), or review content information created for the service.

Additionally, the storage unit 120 may store business operator history information related to the business operator account 200. Here, the business operator history information may include review history information on the services provided by the business operator and linked to the business operator account 200.

The review history information may include review information related to the review content of the services linked to the business operator account 200. For example, the review history information may include at least one of review content information created for the service (e.g., content of review, review items, ratings, etc.), information on the customer who created the review content (e.g., profile information such as the customer's name, age, gender, location, account, activity history, etc.), information on the date of visit of the customer who created the review content, information on the occasion (or times) when the review content was created, or reply information created by the business operator account 200 regarding the review content.

Further, the storage unit 120 may store various information related to the customer account 300. Here, the various information related to the customer account 300 may include at least one of customer's history information or customer's metadata.

For example, the customer's history information may include information related to various events that have occurred in the customer account 300. For example, the events that occur in the customer account 300 may include: i) selecting to register a specific service as a place of interest, ii) performing a reservation process to reserve a specific service, iii) searching for a location and/or searching for a route (e.g., searching through a navigation service or map service, etc.), iv) selecting a document (e.g., a webpage, image, video, etc.), v) creating review content for a specific service, and the like.

Accordingly, the customer's history information may include, for example, at least one of i) the customer's places of interest, ii) information related to the services reserved by the customer (e.g., reservation date, reservation items, reservation details, etc.), iii) the customer's place and/or route search history, iv) the customer's document search and/or selection history, or v) the customer's review content creation history (e.g., content of review, review items, date of creation, rating).

The customer's metadata described above may include information related to at least one of the customer's gender or age. However, the customer's metadata may also include various other information such as the customer's residential area, work area, interests, hobbies, occupation, and more. Such customer's metadata may be matched and exist together with the customer's history information, as previously described. In this case, the customer's metadata may be understood as a concept that includes the customer's history information.

Meanwhile, the control unit 130 may be referred to as a processor and may work in collaboration with memory to perform the role of controlling the overall operation of the system 100 for providing a review management service. The control unit 130 may process signals, data, information, and the like that are input or output through the constituent elements described above, or perform a series of data processing to provide or process appropriate information and/or functions to the user.

The review content created by the customer account 300 and registered on the review page is content generated regardless of the intentions and actions of the business operator operating a business. Among these contents, there may be positive review content, but there may also be malicious review content, rights-infringing review content, negative review content, and/or more.

The business operator account 200, which needs to manage these various types of reviews, may face emotional and/or time-related difficulties in the process of managing the reviews. This may significantly impact the business operator's business operations.

Accordingly, to assist the business operator in managing review content, the control unit 130 may provide a business operator environment with various review content management functions, allowing the business operator to manage various types of review content without being influenced in terms of emotion or time. For example, as illustrated in FIG. 1, the control unit 130 may provide a review management page 10 with various review content management functions through various service platforms, such as an application, a web browser, a program, or software that are installed on the business operator account 200.

According to an example embodiment of the present disclosure, the control unit 130 may use the pre-trained artificial intelligence model of the artificial intelligence server 20 to analyze the content included in the review content. Based on the analyzed information, the control unit 130 may classify the review content into one of multiple ratings defined or preset in the system 100 for providing a review management service. In this case, the control unit 130 may perform different data processing for each of the multiple ratings. The more specific details regarding the multiple ratings defined or preset in the system 100 for providing a review management service will be described below.

According to another example embodiment, the control unit 130 may use the generative artificial intelligence model of the artificial intelligence server 20 to input an input prompt related to the review content into the generative artificial intelligence model. Based on the output value (e.g., a reply) of the generative artificial intelligence model, the control unit 130 may generate a draft reply for the review content. Further, the control unit 130 may match the generated draft reply with the corresponding content and provide it to the business operator account 200 through the review management page 10.

Hereinafter, based on the configuration of the system 100 for providing a review management service described above, a method of providing a review management service that enables the business operator account 200 to manage review content through various functions will be described in more detail.

Meanwhile, in an example embodiment of the present disclosure, a process of monitoring the registration of review content on the review page may be carried out (S310, see FIG. 3).

The control unit 130 may monitor the registration of review content on a review page 400 (see FIG. 4). For example, the control unit 130 may monitor whether the review content created by the customer account 300, who received a specific service, is registered on the review page 400.

The control unit 130 may provide a user environment that allows a customer, who received a service from the business operator, to create review content for the service. In the storage unit, there is a review page linked to each business (or service) registered under the user account, and the control unit 130 may provide a specific review page to the customer terminal 20.

For example, as illustrated in FIG. 4, the control unit 130 may, based on the completion of the provision of a specific service (e.g., food provision) provided by the business operator account 200 to the customer account 300, provide the review page 400 to the customer account 300, allowing the customer to create review content for the specific service.

That is, the review page 400 provided to the customer account 300 may be a page configured to allow the customer to create review content for a specific service linked to the business operator account 200. Further, the review page 400 may be a page linked to the system 100 for providing a review management service.

The review page may be accessible not only to the customer and business operator but also to various users, including third parties. The users may check the evaluations of other users regarding the corresponding business (or service) through the review content registered on the review page.

In some example embodiments of the present disclosure, as a result of monitoring, when the review content is monitored as being registered on the review page, a process of analyzing the content included in the review content through a pre-trained artificial intelligence model may be carried out (S320, see FIG. 3).

In some example embodiments of the present disclosure, the phrase “review content registration is monitored” may also be understood as “receiving the review content.”

As illustrated in FIG. 4, the customer account 300 may create review content for a specific service received from the business operator account 200 through the review page 400. The completed review content (e.g., “I visited again, boss˜ Why is all the food so delicious?! Haha, I was amazed while eating because your skills are just incredible. The food feels full of care . . . ” 410) may be registered on the review page 400 (S210, see FIG. 2).

As a result of monitoring, when the review content 410 created by the customer account 300 is registered on the review page 400, the control unit 130 may receive the review content 410 registered on the review page 400.

Based on the registration of the review content 410 on the review page 400, the control unit 130 may analyze the content included in the review content 410 through a pre-trained artificial intelligence model.

The analysis of the review content may be carried out in various ways. For example, the analysis of the review content may include semantic analysis of the review text content included in the review content, keyword extraction, and others. For example, the analysis of the review content may be conducted by considering the context and nuances of the words and/or sentences that make up the text, and by comprehensively considering the intention, emotions, and/or attitude toward the subject of the review of the review creator who created the review content.

The control unit 130 may extract emotional information of the review creator, who created the review content, from the content of the text included in the review content. The control unit 130, using a pre-trained artificial intelligence model, may specify whether the review creator's emotions toward the review subject are positive or negative by considering factors such as the words included in the review content, the presence of specific words, expressions conveyed through specific words, the meaning (context) of specific words, nuances, and/or others.

The control unit 130 may conduct training of the artificial intelligence model with various training data to enable the analysis of the review creator's emotions. The training data may include words (or keywords) included in the review content according to the review creator's emotions.

The control unit 130 may analyze whether the review content is a negative review or a positive review using the artificial intelligence model trained with the training data.

For example, the control unit 130 may, based on the fact that the review content includes complaint content (e.g., “a review including complaints” such as “I am not satisfied,” “I am disappointed,” “This is the worst,” “They are rude,” “The food is bad,” “The hygiene is poor,” etc.) about the review subject (e.g., business operator, staff, service, business, etc.), content that infringes on the business operator's human rights (e.g., “a rights-infringement review” such as insults, belittlement, curses, strong negativity, direct rude language towards staff or management), or malicious content (e.g., profanity, violent expressions, hate expressions) intended to harm the business operator, analyze the corresponding review content as a negative review. In contrast, when the review content includes positive content for the review subject or does not include any malicious content intended to infringe or harm the rights of the business operator, etc., the control unit 130 may classify the corresponding review content as a positive review.

Further, based on the analysis, a process of classifying the review content into one of multiple ratings may be carried out (S330, see FIG. 3). A process of classifying the review content into one of multiple ratings may be carried out by the system 100 (S220, see FIG. 2).

The control unit 130 may distinguish the review content into one of the different multiple ratings, based on the analysis results of the review content registered on the review page.

For example, in some example embodiments of the present disclosure, to enable the business operator to safely manage various types of review content, the review content may be distinguished into one of multiple ratings based on the text content included in the review content.

To this end, review content ratings including multiple ratings may be set and exist in the system 100 for providing a review management service. Here, the multiple ratings may include a rating distinguished based on positive reviews and multiple ratings distinguished based on negative reviews. For example, as illustrated in FIG. 5, a review content rating 500 may include multiple ratings 510, 520, and 530 distinguished based on negative reviews, as well as a rating PASS 540 distinguished based on positive reviews.

The multiple ratings 510, 520, and 530 distinguished according to negative reviews may be understood as ratings that are classified based on which degree of negative review the negative review corresponds to. In an example embodiment of the present disclosure, rating A 510 may be associated with the highest level of negative review (or malicious review), rating B 520 may be associated with a negative review (or rights-infringing review) lower than the highest level of negative review, and rating C 530 may be associated with a negative review (or complaint-included review) lower than rating B 520.

Based on the analysis results, the control unit 130 may determine which degree of negativity, among multiple degrees of negativity, the review content specified as a negative review corresponds to, and based on the determination results, the review content may be distinguished as one of multiple ratings.

For example, in an example embodiment of the present disclosure, based on the content of the text included in the review content, “malicious review” may be specified as the highest degree of negativity, and “rights-infringing review” may be specified as the second-highest degree of negativity. Further, “complaint-included review” may be specified as a lower degree of negativity among the degrees of negativity

Based on the analysis results of the review content, the control unit 130 may determine whether the content included in the review content falls under “malicious review,” “rights-infringing review,” or “complaint-included review.” Based on this determination results, the control unit 130 may determine the rating of the review content according to the degree of negativity.

Further, each of the multiple ratings 510, 520, 530, and 540 included in the review content rating 500 may have matching text that serves as the criteria for distinguishing the rating. For example, among the multiple ratings 510, 520, and 530 based on negative reviews, rating A 510 may have matching text related to profanity, violent expressions, hate expressions, etc., rating B 520 may have matching text related to insults, belittlement, curses, strong negativity, or direct rude language toward staff or management (e.g., “You're ugly,” “You're fat,” “The staff is terrible,” “The food tastes awful,” “This place should be shut down,” “Eat this crap, and hey, do your job properly, part-timer,” etc.), and rating C 530 may have matching text containing negative content or suggestions for improvement, including any somewhat negative or disappointing content (e.g., “Rude service,” “Not great,” “Poor hygiene,” “Too much fat,” “The tteokbokki is too sweet, it's good but too expensive,” etc.).

In contrast, the rating PASS 540, distinguished based on positive reviews excluding negative reviews, may have matching text related to positive reviews that would be completely acceptable for the business operator to check later (e.g., “I heard there might be a wait even on weekdays, and now I understand why, the taste is that good!”, “Best place for samgyeopsal!”, “I highly recommend the volume perm with Suji designer!,” etc.).

These review content ratings 500 may be efficiently utilized in the process of analyzing (or classifying) which rating the review content of customers registered on the review page falls under.

As an example, the control unit 130 may use the review content ratings 500 as training data for the artificial intelligence model and train the artificial intelligence model. In this case, the artificial intelligence model may perform tasks such as sentiment analysis, topic analysis, and text classification through the analysis of the text content included in the review content.

Meanwhile, the control unit 130 may perform an analysis of the content included in the review content using the pre-trained artificial intelligence model of the artificial intelligence server 20.

As described above, the artificial intelligence model of the artificial intelligence server 20 may be pre-trained to perform analysis (or classification) tasks on the content included in the review content. For example, the artificial intelligence model may be a model trained using the review content ratings 500 as training data.

For example, the pre-trained artificial intelligence model used in some example embodiments of the present disclosure may perform analysis (or classification) tasks on the content included in the review content by considering both the context and nuance.

Context refers to the surrounding environment or situation in which words, phrases, sentences, etc. are used. This may include the paragraph or topic in which a word or sentence is contained, as well as preceding and succeeding statements, and even the occasion of the statement. For example, context may help in understanding what a word means in a specific situation, when the corresponding word may have multiple meanings. Additionally, context may help in understanding the implicit meaning or implied information contained in a sentence or expression (e.g., jokes, sarcasm, etc.).

Nuance may include subtle differences or detailed emotions, intentions, and others within text or speech. Understanding nuance is a crucial or important element in more accurately understanding the meaning of a corpus, as well as in more precisely interpreting emotions or tone (attitude). For example, nuance may be essential in identifying positive or negative sentiment in reviews or opinions, and it may help in reading sarcasm, encouragement, or other intentions through subtle changes in tone or the selected words.

That is, because the artificial intelligence model more accurately understands context and/or nuance, and performs analysis (or classification) tasks on the content included in the review content, it may exhibit improved performance in the analysis (or classification) task.

In an example embodiment of the present disclosure, the analysis of the content included in the review content may be understood as a process of classifying the review content into one of the ratings based on whether the review content is a positive or negative review through the analysis of the content included in the review content. For example, it is assumed that there is a specific review content 550 registered on the review page, as illustrated in FIG. 5. In this case, the control unit 130 may perform an analysis of the specific review content 550 using the pre-trained artificial intelligence model. In this case, the control unit 130 may classify the specific review content 550 as the rating PASS 540 according to the positive review, based on the fact that the text content (e.g., “This was my first time trying a handmade burger, and it was really, really delicious! The patty was incredibly juicy . . . . The more I chewed, the more delicious and savorier it became. There were a lot of fresh vegetables, so it felt somewhat like a healthy meal haha. The subtle smoky flavor was also great.”, 551) containing the specific review content 550 includes text related to the positive review (e.g., “It was really, really delicious!”, “The vegetables were fresh and abundant, so it felt like a healthy meal”).

Meanwhile, in an example embodiment of the present disclosure, based on which rating of multiple ratings the review content has been classified into, a process of performing one of the multiple different review management processes to handle the review content may be carried out (S340, see FIG. 3). A process of specifying one of the multiple different review management processes based on a rating of the review content (S230, see FIG. 2) and a process of providing the process to the business operator account (S240, see FIG. 2) may be carried out by the system 100. Further, the business operator account 20A may check reviewed created and posted by the customer account 300 based on the review rating classified by the system 100 (S250, see FIG. 2).

As in the S330 process described above, the control unit 130 may classify the review content into one of the ratings based on whether the review content is a positive or negative review through analysis of the content included in the review content.

In this case, based on which rating of multiple ratings the review content has been classified into, the control unit 130 may perform one of the multiple different review management processes to handle the review content (S340, see FIG. 3).

In this regard, as illustrated in FIG. 6, each of the multiple ratings 610, 620, 630, and 640 may be matched or associated with one of the multiple different review management processes.

First, based on which degree of negative review the review content corresponds to among the negative reviews, a process for performing different data processing for the review content will be described.

The control unit 130 may determine whether to expose the review content on the review page based on which degree of negative review the review content corresponds to among the negative reviews.

As illustrated in FIG. 6, when, based on the classification results, the review content is classified as a negative review of the highest rating (or rating A, 610) among the multiple ratings 610, 620, 630, and 640, in response to the review content being monitored during the monitoring stage, the control unit 130 may process the review content as non-exposure 612 from the review page to ensure that the review content is not exposed to users (or customers) accessing the review page.

Additionally, the review content classified as a negative review of the highest rating 610 may not be exposed even to the business operator account 200, which accesses the review management page for managing the review content. That is, the control unit 130 may process the review content as non-exposure 612 from the review management page so that the review content is not exposed to business operators accessing the review management page.

Further, when the review content is classified as a negative review of the highest rating 610, the control unit 130 may limit the provision of notification information 611 to the business operator account 200 on the review page, indicating that the review content has been registered on the review page.

That is, in an example embodiment of the present disclosure, by immediately blocking malicious reviews, it is possible to protect both the business operator and the users, while providing a user environment that allows the business operator to manage reviews without suffering from the damage caused by malicious reviews.

In contrast, when, based on the classification results, the review content is classified as a negative review of a lower rating (or rating B, 620) than the negative review of the highest rating 610, in response to the review content being monitored during the monitoring stage, the control unit 130 may transmit notification information 621 to the business operator terminal logged in with the business operator account 200, indicating that the review content has been registered on the review page.

Additionally, the control unit 130 may process the review content corresponding to the negative review of rating B 620 to be exposed on the review management page provided to the business operator terminal of the business operator account 200 (622). The control unit 130 may also provide guide information 623 along with the review content, indicating that the review content contains negative content (e.g., content related to a rights-infringing review). For example, as illustrated in FIG. 7A, the control unit 130 may provide guide information (e.g., “Is this a rights-infringing review?”, 712) in one area 710 of a review management page 700, along with review content 711 corresponding to the negative review of rating B 620, indicating that the review content contains 711 negative content.

In this case, the guide information may further include a post suspension request button 712, which suspends the posting of the review content 711 corresponding to the negative review of rating B 620 from the review page 700. As an example, the business operator account 200 may select the post suspension request button 712 to transmit a post suspension request, which suspends the posting of the review content 711, to the server of the review management system 100.

Further, when, based on the classification results, the review content is classified as a negative review of a lower rating (or rating C, 630) than the negative review of rating B 620, in response to the review content being monitored during the monitoring stage, the control unit 130 may transmit notification information 631 to the business operator terminal logged in with the business operator account 200, indicating that the review content has been registered on the review page.

Additionally, the control unit 130 may process the review content corresponding to the negative review of rating C 630 to be exposed on the review management page provided to the business operator terminal of the business operator account 200 (632). The control unit 130 may also provide guide information 633 along with the review content, indicating that the review content contains negative content (e.g., content that includes complaints). For example, as illustrated in FIG. 7B, the control unit 130 may provide guide information (e.g., “This review contains negative or suggestions for improvement.”, 722) in one area 710 of the review management page 700, along with the review content 721 corresponding to the negative review of rating C 630, indicating that the review content 721 contains negative content.

As described above, when the review content is classified as a negative review (for example, the negative review of rating B and negative review of rating C), the control unit 130 may provide guide information, indicating that the review content contains negative content, along with the review content on the review management page.

That is, in an example embodiment of the present disclosure, the relatively high visibility attention guidance for negative reviews may facilitate quicker responses and/or reporting.

Meanwhile, when the review content is classified as a rating PASS 640 corresponding to a positive review rather than a negative review, the control unit 130 may transmit notification information 641 to the business operator terminal logged in with the business operator account 200, indicating that the review content has been registered on the review page, in response to the review content being monitored during the monitoring stage. In this case, the notification information 641 may be provided individually each time a review of rating PASS is registered on the review page, or it may be collectively provided all at once.

Additionally, the control unit 130 may process the review content corresponding to the positive review of rating PASS 640 to be exposed on the review management page provided to the business operator terminal of the business operator account 200 (642). For example, as illustrated in FIG. 7C, the control unit 130 may process the review content 731 to be exposed, corresponding to the positive review of rating PASS 640 in one area 710 of the review management page 700.

Further, a draft reply may be generated only when the review content is classified into a rating corresponding to desired or preset conditions among the multiple ratings. For example, a draft reply may not be generated for review content of the highest rating 610 that is not exposed on the review management page. As another example, a draft reply may be generated for review content corresponding to the rating B 620, rating C 630, and rating PASS 640, excluding the highest rating 610. The more specific details regarding the draft reply will be described below.

As described above, in an example embodiment of the present disclosure, the review management process may provide a draft reply for the review content based on the artificial intelligence model. Based on this, an example embodiment of the present disclosure may provide an automated service for replies conventionally created and provided by the business operator.

In an example embodiment of the present disclosure, “draft reply” may be understood as the business operator's reply to the customer's review content. In an example embodiment of the present disclosure, a customized draft reply may be generated and provided based on the content of each review content.

In the method and system for providing a review management service according to some example embodiments of the present disclosure, a draft reply may be generated using a generative artificial intelligence (Generative AI) model. Further, because the generative artificial intelligence model may be named using various terms, no specific limitation is placed on the terms in the present disclosure.

Meanwhile, the generative artificial intelligence model utilized in some example embodiments of the present disclosure is not limited in type, and any language model that has been trained on various types of information is sufficient. For example, the generative artificial intelligence model is HyperCLOVA, generative pre-trained transformer 3 (GPT), etc., and such large language models may also be utilized in some example embodiments of the present disclosure.

The system 100 for providing a review management service according to an example embodiment of the present disclosure may be configured to interact with a generative artificial intelligence model. That is, the system 100 for providing a review management service generates a draft reply using the generative artificial intelligence model. At least a part of the configuration of the review management system 100 may input information to the generative artificial intelligence model or perform the role of processing the information output from the generative artificial intelligence model.

Further, it is obvious that the system 100 for providing a review management service according to some example embodiments of the present disclosure may be configured to include a generative artificial intelligence model.

In an example embodiment of the present disclosure, a process of monitoring the registration of review content on the review page may be carried out (S810, see FIG. 8).

The control unit 130 may provide a draft reply generation service as part of the review management process. In an example embodiment of the present disclosure, the draft reply generation service may be provided through a review management process matched to a specific rating among the multiple ratings.

As described above, in some example embodiments of the present disclosure, the review content may be classified into multiple ratings based on the content included in the review. Each of the multiple ratings may be matched or associated with a different review management process. Among these, the review management processes matched to specific ratings (rating B, rating C, and rating PASS) may include the draft reply service. The review management process matched to other ratings (rating A) may not include the draft reply service.

The control unit 130 may monitor whether review content, which is subject to the provision of draft reply service, has been registered on the review page. For example, the control unit 130 may monitor the registration of at least one review content of rights-infringing reviews, complaint reviews, or positive reviews that fall under specific ratings (rating B, rating C, and rating PASS). The review content described below may correspond to review content belonging to a specific rating.

In some example embodiments of the present disclosure, when the registration of review content is monitored, a process of extracting specific information included in the review content based on desired or preset conditions may be carried out (S820, see FIG. 2).

In some example embodiments of the present disclosure, the review content may include review information corresponding to different multiple categories (attributes or fields). As illustrated in FIG. 9, the review content may include at least one of i) information (or user information) on a creator who created the review content (e.g., the creator's nickname “Grini” 911), ii) visit date and visit count information of the creator who visited the business where the review content is registered (e.g., “visit date: 2024.03.05 (Wed)”, 912), iii) review media (photos or videos, 913), iv) information on a product that is a subject of the review content (e.g., “reserved product name: chicken salad and 1 other menu item”, 914), v) review text 915, or vi) keyword information (e.g., “The food is delicious”, 916).

The control unit 130 may extract review information related to at least one of the multiple categories from the review content. In this case, the control unit 130 may match categories with information corresponding to the categories as pairs and extract the information.

Further, the control unit 130 may extract business information registered under the business operator account based on desired or preset conditions. Various information may be stored in the storage unit 120 by matching with the business operator account. The control unit 130 may extract at least one of trade name (e.g., “Kim's Restaurant” 921), industry type (e.g., “Handmade Burger Shop” 922), or business description information 923 of the business registered under the business operator account.

In some example embodiments of the present disclosure, a process of creating an input prompt for the generative artificial intelligence model using the extracted specific information may be carried out (S830, see FIG. 8).

The control unit 130 may generate a prompt to be input into the generative artificial intelligence model using the business information registered under the business operator account and feature information extracted from the review content.

As described above, in some example embodiments of the present disclosure, by utilizing the generative artificial intelligence model, a reply content from the business operator for the review content registered by the customer may be generated and provided to the business operator. The business operator may manage the review content using the AI draft reply providing service according to some example embodiments of the present disclosure, without the need to directly and individually create replies to customer review content.

The control unit 130 may generate a prompt using the feature information (review category corresponding to the feature information) and business information to enable the generation of the business operator's reply to the review content. For example, as illustrated in FIG. 9, the control unit 130 may create a prompt to generate a business operator's reply content to the content of the review content with the review content creator's nickname (e.g., “Grini”) as the recipient of a draft reply 930 and the trade name of the business registered under the business operator account (e.g., “Kim's Restaurant”) as the reply creator.

In this case, the control unit 130 may generate a prompt such that at least one of the text, video, keywords, visit date, or visit count information included in the review content is included in the draft reply. For example, the control unit 130 may generate a prompt to ensure that a draft reply is created, including specific keywords (e.g., “first visit,” “handmade burger,” “patty's juiciness,” “freshness of the vegetables,” “smoky flavor,” etc.), which are included in at least one of the text, video, keywords, visit date, or visit count information included in the review content.

The control unit 130 may generate a prompt to ensure that a draft reply is created by incorporating not only the review text content included in the review content but also various review information such as the nickname of the creator who created the review, the number of times the creator has visited the business, the visit date, and/or the business information.

The control unit 130 may generate a prompt to ensure that a draft reply is created in the form of a reply to the review text content included in the review content. For example, when there is content that needs to be explained in the review content, the control unit 130 may generate a prompt to ensure that the corresponding content is explained based on the business description information matched to the business operator account. As another example, the control unit 130 may generate a prompt to repeat, emphasize, or agree with at least some of the content included in the review content. The review content includes content recommending a specific menu of the business, and the control unit 130 may generate a prompt to generate a draft reply agreeing to the recommendation of the specific menu.

Further, the control unit 130 may generate a prompt using the analysis result information based on the content included in the review content. As described above, the control unit 130 may classify the review content as a positive review or a negative review through the analysis of the content included in the review content. Further, the control unit 130 may classify the review content into different multiple ratings (at least one of malicious review, rights-infringing review, or complaint review) based on the degree to which the review content is a negative review.

The control unit 130 may generate a prompt such that, based on the rating to which the review content belongs, at least one of the words, context, tone, or manner of expression included in the draft reply is modified. That is, the control unit 130 may generate a prompt such that, depending on the content rating, at least one of the content or style (atmosphere, nuance) of the draft reply is modified. For example, the control unit 130 may generate a prompt such that, for negative reviews, a polite toned draft reply is generated, while for positive reviews, a more upbeat and lively toned draft reply is created.

Further, the control unit 130 may generate a prompt to include emojis or emoticons in the draft reply. The control unit 130 may generate a prompt to ensure that at least one emoji corresponding to the content of the draft reply is included between the sentences or words that make up the draft reply.

Additionally, the control unit 130 may generate a prompt based on the reply history record matched or associated with the business operator account. The detailed description will be provided below, but in some example embodiments of the present disclosure, multiple draft replies (e.g., option 1, option 2, option 3, etc.) may be provided, and the business operator may select and register one of the multiple draft replies. Further, in some example embodiments of the present disclosure, an edit function for the draft reply generated by the generative artificial intelligence model may be provided, allowing the business operator to edit the draft reply and register it on the review management page.

In the business operator account, the replies registered by the business operator account and the review content corresponding to the replies may be matched and exist as the reply history record. The control unit 130 may generate a prompt to generate a draft reply corresponding to a desired reply style in the business operator account based on the reply history record.

For example, the control unit 130 may generate a prompt to include more emojis when, based on the history record of the business operator account, the business operator uses a lot of emojis. As another example, when a reply sentence (e.g., a reply sentence directly created) that is repeatedly added by the business operator exists, the control part 130 may generate a prompt to include the corresponding reply sentence. As another example, when the history record indicates that the business operator likes a draft reply with a specific atmosphere (e.g., an upbeat and lively atmosphere or playful atmosphere), the control unit 130 may generate a prompt to generate the draft reply with the specific atmosphere.

In some example embodiments of the present disclosure, a process of obtaining a draft reply for the review content from a generative artificial intelligence model, which receives an input prompt as input, may be carried out (S840, see FIG. 8).

As illustrated in FIG. 9, the control unit 130 may input a prompt into the generative artificial intelligence model to obtain the draft reply 930 corresponding to the review content. Such a draft reply may be generated differently, based on as least one of who is a creator who created the review content, the business that is the subject of the review content, or the content included in the review content, being different.

As described above, by automatically generating prompts based on the review content, some example embodiments of the present disclosure enable the business operator to be provided with an automatically generated AI draft immediately after the customer's review content is registered, with no process of creating a reply to the review content or a prompt for a reply, or pressing a button.

Further, in some example embodiments of the present disclosure, a process of providing the draft reply on the management page that manages the review page may be carried out (S850, see FIG. 8).

As illustrated in FIG. 10A, the control unit 130 may provide a review management page 1000 to the business operator terminal of the business operator account. Here, the review management page 1000 may be a review management page matched to a specific business registered under the business operator account. In an example embodiment of the present disclosure, a review management page is created for each business registered under the business operator account. The control unit 130 may provide the review management page matched to a specific business (e.g., the review management page for “Kim's Restaurant” 1000) to the business operator terminal in response to the business operator account's request.

The control unit 130 may provide the review content 910 and the draft reply 930 to the review content as a pair on the review management page 1000. Although only one pair of review content 910 and draft reply 930 is shown in FIG. 10A, the review management page 1000 may be provided with a pair of draft replies corresponding to each of multiple pieces of review content.

For example, the review management page 1000 displays a specific review content 910 and the draft reply 930 corresponding to the specific review content as a pair, and another review content, which is different from the specific review content, is displayed along with another draft reply corresponding to the other review content as a pair. That is, the review management page 1000 may be configured to include a review area 1010 in which the review content 910 is displayed and a reply area 1020 in which the draft reply 930 is displayed, with the review area and reply area alternating repeatedly (review area-reply area-review area-reply area-review area-reply area).

Meanwhile, the control unit 130 may register the draft reply as a reply to the review content on at least one of the review page or the review management page, based on a draft reply registration request received from the business operator terminal with the business operator account logged in through the review management page 1000. As illustrated in FIG. 10B, the control unit 130 may, based on the draft reply registration request, register the draft reply 930 on the review management page 1000, by matching the draft reply with the review content 910. The control unit 130 may, in the lower area 1020 of the review area 1010 where the review content 910 is provided, register the draft reply 930 on the review management page 1000 by having the trade name registered under the business operator account (e.g., “Kim's Restaurant” 941) as the reply creator and specifying the date of the draft reply registration request as the reply creation date (e.g., “03/15 (Fri)” 942). Further, the control unit 130 may expose the draft reply 930 in linkage to the review content 910, so that the draft reply 930 registered on the review management page 1000 is exposed to users (e.g., customers) accessing the review page. That is, the control unit 130 may, in response to the draft reply registration request, expose the draft reply in linkage to both the review page and the review management page.

Meanwhile, as illustrated in FIG. 10A, the specific area (or reply area, 1020) where the draft reply 930 is provided may include at least one of a function icon linked to the draft reply registration request (e.g., “Register as is”, A), a function icon linked to another draft reply request (e.g., “View other replies”, B), or a function icon linked to a edit request to a draft reply (e.g., “Edit this reply”, C).

The control unit 130 may process the function linked to the selected icon based on the selection of one of the multiple function icons from the business operator terminal. The control unit 130 may, based on the selection of the function icon linked to the draft reply registration request (e.g., “Register as is”, A), expose the draft reply on at least one of the review management page or the review page, as described above.

As illustrated in FIG. 11, the control unit 130 may, based on the selection of the function icon linked to another draft reply request (e.g., “View other replies”, B) from the business operator terminal, generate a draft reply and another draft reply using the prompt. As described above, the control unit 130 may generate a prompt using the feature information extracted from the review content and the business information registered under the business operator account. The control unit 130 may input the generated prompt into the generative artificial intelligence model to obtain a draft reply that is different from the previously created draft reply. In this case, the control unit 130 may generate a different prompt from the obtained prompt for a creation of a desired draft reply, and input the different prompt into the generative artificial intelligence model. For example, the control unit 130 may input a new prompt into the generative artificial intelligence model to ensure that a draft reply with different content from the previously created draft reply is generated.

Each time the function icon linked to another draft reply request (e.g., “View other replies”, B) is selected from the business operator terminal, the generative artificial intelligence model may use the prompt to generate a new draft reply. For the convenience of description, in some example embodiments of the present disclosure, the draft replies will be named and described as a first draft reply (or draft reply option 1), a second draft reply (or draft reply option 2), and a third draft reply (or draft reply option 3) according to the order of creation of the draft replies.

As illustrated in (a) of FIG. 11, in a state where a first draft reply 1110 is initially provided, the control unit 130 may, based on the selection of the function icon linked to another draft reply request (e.g., “View other replies”, B) from the business operator terminal, utilize the generative artificial intelligence model to obtain a second draft reply that is different from the initial draft reply.

As illustrated in (b) of FIG. 11, the control unit 130 may provide a second draft reply 1120 in a specific area (or reply area) where the draft reply is provided. In this case, the control unit 130 may display graphic objects (e.g., “option 1”, “option 2”, 1110a, 1120a) corresponding to each of the multiple draft replies in the specific area. Further, the control unit 130 may highlight the graphic object (“option 2”, 1120a) corresponding to the draft reply displayed in the specific area. When the graphic object 1110a or 1120a is selected, the control unit 130 may display the draft reply corresponding to the selected graphic object in the specific area. For example, in a state where the second draft reply 1120 is displayed in the specific area, when the graphic object 1110a corresponding to the first draft reply 1110 is selected, the control unit 130 may display the first draft reply 1110 in the specific area. The business operator may select the graphic objects 1110a and 1120a to view and compare the multiple draft replies, and then select and register one of the multiple draft replies.

Further, as illustrated in (c) of FIG. 11, in a state where multiple draft replies have been created, the control unit 130 may, based on the selection of the function icon linked to another draft reply request (e.g., “View other replies”, B) from the business operator terminal, continue to generate and provide a new draft reply (e.g., a third draft reply, 1130). Further, the control unit 130 may generate a graphic object 1130a linked to the new draft reply 1130 and provide it in the specific area.

The business operator may continue to select the function icon linked to another draft reply request (e.g., “View other replies”, B) until the desired draft reply is generated, thereby being provided with a new draft reply. The control unit 130 may limit the generation of new draft replies to a preset limited number of times or a set number of times (e.g., 10 times). The control unit 130 may limit the generation of any further new draft replies, so that even if the function icon linked to another draft reply request (e.g., “View other replies”, B) is selected with the tenth draft reply generated and provided.

Meanwhile, the control unit 130 may, in response to the selection of one of the draft reply or another draft reply from the business operator terminal, register the selected draft reply as a reply to the review content on both the review page and the review management page.

As illustrated in (c) of FIG. 11, in a state where multiple draft replies have been generated and one of the multiple draft replies is displayed in the specific area, the control unit 130 may, in response to the selection of the function icon linked to the draft reply registration request (e.g., “Register as is”, A) from the user terminal, register the displayed draft reply (e.g., the third draft reply, 1130) on both the review page and the review management page. The business operator may select one of the graphic objects corresponding to the multiple draft replies (e.g., option 3, 1130a) to display a specific draft reply in the specific area. Then, by selecting the function icon linked to the draft reply registration request (e.g., “Register as is”, A), the business operator may register the desired draft reply as a reply to the review content.

Meanwhile, in some example embodiments of the present disclosure, an edit function may be provided that allows the business operator to directly edit the draft reply generated by the generative artificial intelligence model. The business operator may, through the edit function, edit at least part of the draft reply generated by the generative artificial intelligence model and register it on both the review management page and the review page.

As illustrated in (a) of FIG. 12, in a specific area where a draft reply 1200 is provided on the review management page, a function icon (e.g., “Edit this reply”, C) may be included along with the draft reply 1200 to request an edit of the draft reply. The control unit 130 may, when the function icon C is selected from the business operator terminal 30, change the draft reply to an editable state. For example, as illustrated in (b) of FIG. 12, the control unit 130 may change an area where the draft reply is displayed into a text field area, allowing the user to input text. The displayed area may be changed into a text field, modification area, or edit area. When the draft reply is changed to an editable state, the business operator may change at least part of the draft reply or add new content. Based on the information received through the business operator terminal, the control unit 130 may edit the draft reply 1200 generated by the generative artificial intelligence model and obtain the edited draft reply 1200a.

With the draft reply edited, the control unit 130 may, in response to the selection of the function icon linked to the draft reply registration request (e.g., “Register as is”, A) from the user terminal, register the edited draft reply 1200a on both the review management page and the review page.

As described above, the method and system for providing a review management service according to some example embodiments of the present disclosure can monitor the registration of review content on a review page, and analyze the content included in the review content using a pre-trained artificial intelligence model when the monitoring results indicate that the review content has been registered on the review page. Therefore, some example embodiments of the present disclosure enable relatively quick analysis of review content and/or provides relatively immediate feedback to the business operator.

Further, the method and system for providing a review management service according to some example embodiments of the present disclosure can perform classification of the review content into one of the multiple ratings based on the above analysis, and one of the multiple different review management processes that handle the review content based on which rating of the multiple ratings the review content is classified into. Therefore, some example embodiments of the present disclosure enable appropriate responses based on each rating, protecting the business operator from malicious reviews. The business operator can reduce the emotional and/or time costs of creating direct replies to review content, provide appropriate replies based on the content of the reviews registered by the customer, and/or improve customer engagement and services, allowing for more efficient business operation.

Meanwhile, some example embodiments of the present disclosure described above may be executed by one or more processors on a computer and implemented as a program that may be stored on a computer-readable medium (or recording medium).

Further, some example embodiments of the present disclosure described above may be implemented as computer-readable code or instructions on a medium in which a program is recorded. That is, some example embodiments of the present disclosure may be provided in the form of a non-transitory computer-readable medium storing a program or computer-readable instructions therein.

Meanwhile, the computer-readable medium may include all kinds of recording devices for storing data readable by a computer system. Examples of computer-readable medium include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to some example embodiments of the present disclosure from the server or cloud storage, through wired or wireless communication.

Further, in some example embodiments of the present disclosure, the computer described above may be an electronic device equipped with a processor, that is, a central processing unit (CPU), and is not particularly limited to any type.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

Meanwhile, it should be appreciated that the detailed description is interpreted as being illustrative in every sense, not restrictive. Example embodiments of the present disclosure should cover the modifications and variations of the disclose example embodiments within the scope of the appended claims and their equivalents.

What is claimed is:

1. A method of providing a review management service, comprising:
monitoring registration of review content on a review page;
analyzing content included in the review content through a pre-trained artificial intelligence model upon a result of the monitoring indicating that the review content has been registered on the review page;
classifying the review content into a rating of multiple ratings based on a result of the analyzing, each of the multiple ratings being associated with multiple different review management processes; and
performing one of the multiple different review management processes associated with the rating of the review content to handle the review content.

2. The method of claim 1, wherein the analyzing includes:
classifying the review content into one of the multiple ratings based on whether the review content is a positive review or a negative review through an analysis of content included in the review content; and
determining whether the review content is exposed on the review page based on which degree of negative review the review content corresponds to among a plurality of negative reviews.

3. The method of claim 2, wherein, when the review content is classified as the negative review of a highest rating among the multiple ratings, in response to the result of the monitoring, the determining determines that the review content is processed not to be exposed on the review page so that the review content is not exposed to users accessing the review page.

4. The method of claim 3, wherein, when the review content is classified as the negative review of the highest rating, a business operator account of the review page is limited in provision of notification information indicating that the review content has been registered on the review page.

5. The method of claim 3, wherein, when the review content is classified as the negative review of a lower rating than the negative review of the highest rating, in response to the results of the monitoring, notification information indicating that the review content has been registered on the review page is transmitted to a business operator terminal with a business operator account logged in.

6. The method of claim 5, further comprising:
providing a review management page to the business operator terminal of the business operator account,
wherein the review management page includes guide information along with the review content, the guide information indicating that the review content corresponding to the negative review includes negative content.

7. The method of claim 6, wherein the guide information further includes a post suspension request button to suspends posting of the review content from the review page.

8. The method of claim 2, wherein at least one of the multiple different review management processes includes providing a draft reply to the review content using a generative artificial intelligence model.

9. The method of claim 8, further comprising:
providing a review management page to a business operator terminal of a business operator account,
wherein the review management page includes the review content and the draft reply for the review content as a pair.

10. The method of claim 9, further comprising:
generating a prompt to be input into the generative artificial intelligence model,
wherein the generating includes generating the prompt using business information registered under the business operator account and feature information extracted from the review content.

11. The method of claim 10, wherein
the business information includes at least one of trade name, industry type, or business description registered under the business operator account, and
the feature information includes at least one of video, text, and/or keyword information included in the review content, information on creator who created the review content, visit date and/or visit count for a business where the review content is registered, or information on a product that is a subject of the review content.

12. The method of claim 10, further comprising:
providing a function icon for requesting another draft reply, along with the draft reply, in a specific area of the review management page where the draft reply is provided,
generating the draft reply using the prompt when the function icon is selected from the business operator terminal for a first time and
generating another draft reply using the prompt when the function icon is selected from the business operator terminal for a second time after the first time.

13. The method of claim 12, wherein the generating the draft reply includes generating, by the generative artificial intelligence model, a new draft reply using the prompt each time the function icon is selected from the business operator terminal, until reaching a set number of times.

14. The method of claim 12, further comprising:
selecting one of the draft reply or the another draft reply from the business operator terminal; and
registering the selected draft reply as a reply to the review content on the review page.

15. The method of claim 9, further comprising:
providing a function icon for requesting an edit of the draft reply, along with the draft reply, in a specific area of the review management page where the draft reply is provided such that when the function icon is selected, the draft reply is changed to an editable state, and the draft reply is configured to be edited based on information received through the business operator terminal.

16. A method of providing a review management service, comprising:
monitoring registration of review content on a review page;
extracting specific information included in the review content based on conditions, upon a results of the monitoring indicating that the review content has been registered;
creating an input prompt for a generative artificial intelligence model using the extracted specific information;
obtaining a draft reply for the review content from the generative artificial intelligence model that has received the input prompt as an input; and
providing the draft reply to a management page managing the review page.

17. The method of claim 16, further comprising:
registering the draft reply as a reply to the review content on the review page, based on a registration request received from a business operator terminal with a business operator account logged in on a review management page.

18. The method of claim 16, further comprising:
analyzing the review content using a pre-trained artificial intelligence model; and
classifying the review content into one of multiple ratings based on a result of the analyzing,
wherein the obtaining the draft reply includes generating the draft reply only when the review content is classified into a rating that corresponds to a condition among the multiple ratings.

19. A review management system, comprising:
a memory configured to store computer-readable instructions; and
at least one processor configured to execute the computer-readable instructions such that the processor is configured to cause the review management system to,
monitor registration of review content on a review page,
analyze content included in the review content through a pre-trained artificial intelligence model upon a results of the monitoring indicating that the review content has been registered on the review page,
classify the review content into a rating of multiple ratings based on a result of the analyzing, each of the multiple ratings being associated with multiple different review management processes, and
perform one of the multiple different review management processes associated with the rating of the review content to handle the review content.

20. A non-transitory computer-readable recording medium storing a program thereon, which when executed by one or more processors in an electronic device, causes the electronic device to implement a method of providing a review management service, the method comprising:
monitoring registration of review content on a review page;
analyzing content included in the review content through a pre-trained artificial intelligence model upon a result of the monitoring indicating that the review content has been registered on the review page;
classifying the review content into a rating of multiple ratings based on a result of the analyzing, each of the multiple ratings being associated with multiple different review management processes; and
performing one of the multiple different review management processes associated with the rating of the review content to handle the review content.
